(19) United States
(12) Patent Application Publication
(10) Pub. No.: US 2023/0303833 A1
(43) Pub. Date: Sep. 28, 2023

(54) Compositions and Articles of Wave Transmission and Improved Dimensional Radar Cover Material

(71) Applicant: SHPP GLOBAL TECHNOLOGIES B.V., Bergen op Zoom (NL)

(72) Inventors: Yunan Cheng, Shanghai (CN); Xiaoming Jiang, Shanghai (CN); Yun Zheng, Shanghai (CN); Jian Wang, Shanghai (CN)

(21) Appl. No.: 18/021,440

(22) PCT Filed: Aug. 17, 2021
(86) PCT No.: PCT/IB2021/057568

§ 371 Date: Feb. 15, 2023

(30) Foreign Application Priority Data
Aug. 17, 2020 (EP) 20191311.8

(51) Int. Cl. C08L 67/06; C08K 7/14

(52) U.S. Cl. CPC C08L 67/06; C08K 7/14; C08L 2203/206; C08L 2207/20

(57) ABSTRACT

Disclosed herein are compositions comprising: (a) from about 10 wt % to about 87 wt % of at least one crystalline or semi-crystalline polymer, wherein the at least one crystalline or semi-crystalline polymer comprises a crystalline polyester; (b) from about 3 wt % to about 40 wt % of an amorphous polymer resin; (c) from about 10 wt % to about 70 wt % of a reinforcing filler, wherein the at least one crystalline or semi-crystalline polymer may have a lower refractive index than a refractive index of the reinforcing filler when measured using a refractometer, wherein the amorphous polymer resin may have a refractive index value greater than that of the reinforcing filler, and wherein the combined weight percent value of all components does not exceed 100 wt %, and all weight percent values are based on the total weight of the composition.

### FIELD OF THE DISCLOSURE

The present disclosure relates to materials exhibiting microwave transmit properties and light transmit properties, and in particular to materials exhibiting microwave and light transmit properties for automotive radar sensor applications.

### BACKGROUND OF THE DISCLOSURE

Microwave radiation, from about 1 gigahertz GHz (300 millimeter (mm) wavelength) to 300 GHz frequency (1 mm wavelength), is the most common source of electromagnetic energy used in the operation of radar sensors for automotive applications. Radio detection and ranging (RADAR) is the key element of sensing systems in Automobiles. Reinforced or filled polybutylene terephthalate PBT solutions are widely used as radar cover material due to good balance in mechanical, flow and chemical resistance. With the trend of Advanced Driving Assistance System (ADAS), new radio frequencies have been assigned worldwide. As compared to traditional 24 GHz frequencies, 77 GHz has emerged given its high-resolution, long-distance coverage and high-speed adaption. There remains a need in the art for filled materials with desirable mechanical properties and are suitable as internal or external components to transmit MW radiation in automotive radar applications.

Aspects of the present disclosure addresses these and other needs.

### SUMMARY

Aspects of the disclosure relate to a composition comprising: (a) from about 10 wt % to about 87 wt % of at least one crystalline or semi-crystalline polymer, wherein the at least one crystalline or semi-crystalline polymer comprises a crystalline or semi-crystalline polyester; (b) from about 3 wt % to about 40 wt % of an amorphous polymer resin; (c) from about 10 wt % to about 70 wt % of a reinforcing filler wherein the combined weight percent value of all components does not exceed 100 wt %, and all weight percent values are based on the total weight of the composition. The at least one crystalline or semi-crystalline polymer may have a lower refractive index than a refractive index of the reinforcing filler when measured using a refractometer and the amorphous polymer resin may have a refractive index value greater than that of the reinforcing filler. The composition may exhibit a dissipation factor Df less than the dissipation factor observed for a reference composition in the absence of the amorphous polymer resin.

The composition exhibits improved warpage, as determined in accordance with a disclosed method as compared to a comparative composition that does not include the amorphous polymer. The composition may exhibit a dissipation factor (Df) of from about 0.001 to about 2 when determined as a ratio of ε″ and ε′ at frequencies from 1-90 GHz when measured according to a resonant cavity method.

### BRIEF DESCRIPTION OF THE FIGURES

The accompanying figures, which are incorporated in and constitute a part of this specification, illustrate several aspects and together with the description serve to explain the principles of the disclosure.

FIG. 1 presents Table 1-1 showing the formulations of 30% glass filled PBT compositions.

FIG. 2 presents Table 1-2 showing the properties of 30% glass filled PBT compositions.

FIG. 3 presents FIG. 1-3 showing the 250-2500 nm transmission graph of 30% glass filled PBT compositions.

FIG. 4 presents FIG. 1-4 showing the thickness-dependent transmission graph of 30% glass filled PBT compositions.

FIG. 5 presents Table 2-1 showing the formulations of 30% low dk glass filled PBT compositions.

FIG. 6 presents Table 2-2 showing the properties of 30% low dk glass filled PBT compositions.

FIG. 7 presents Table 3-1 showing the formulations containing higher glass filling ratios.

FIG. 8 presents Table 3-2 showing the properties of the compositions containing higher glass filling ratios.

FIG. 9 presents Table 4-1 showing the formulations containing lower glass filling ratios.

FIG. 10 presents Table 4-2 showing the properties of compositions containing lower glass filling ratios.

FIG. 11 presents Table 5-1 showing the formulations of compositions containing different types of additives and fillers.

FIG. 12 presents Table 5-2 showing the properties of compositions containing different types of additives and fillers.

FIG. 13 presents Table 6-1 showing the formulations of compositions containing a different second polymer.

FIG. 14 presents Table 6-2 showing the properties of compositions containing a different second polymer.

### DETAILED DESCRIPTION

The present disclosure relates to filled PBT compositions that may be useful as a radar cover for microwave MW transmitting purposes. Microwave radiation, from about 1 GHz (300 mm wavelength) to 300 GHz frequency (1 mm wavelength), is the most common source of electromagnetic energy used in the operation of radar sensors for automotive applications. The present disclosure provides a series of polymer-based materials that improve upon filled PBT/glass fiber (GF) resin performance as radar covers.

A conventional PBT GF material maintains having a dissipation factor of about 0.015 at 77 GHz and may impact high frequency wave transmission negatively. Filled PBT having a dissipation Df less than 0.01 at 77 GHz may be desired for radar cover purposes. Known methods to decrease the Df of PBT may include blending in a lower Df polymer resin that is miscible (or mixable) with PBT, such as, for example, polypropylene PP. However, as both PBT and PP are crystalline/semi-crystalline polymers, the blends of PBT/PP show severe warpage, making it difficult to be used as a housing material, such as a radar cover.

To meet considerations with the trend of ADAS, a PBT with both low Df and flatness (low warpage) at 77 GHz is critical. Furthermore, due to the increasing number of radar facilitated transport, more efficient means of manufacturing radar device housing have been adapted; for example, laser welding, which requires the radar cover material to allow laser transmission (at 900-1100 nm wavelength). The present disclosure meets these needs. The disclosed compositions low Df PBT blends with minimal warpage, such as, good planar flatness (characterized by low warpage), as well as maximal laser light transmission. The disclosed compositions may combine low Df high RI amorphous resins, PBT and fillers, that provide useful materials for high quality radar cover. In certain aspects, the composition may comprise recycled materials. The present disclosure provides thermoplastic-based glass-filled materials that are rigid and of high modulus that maintain a certain shape when molded and are suitable as internal or external components to transmit MW radiation in automotive radar applications.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, for example, combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including matters of logic with respect to arrangement of steps or operational flow; plain meaning derived from grammatical organization or punctuation; and the number or type of embodiments described in the specification.

### Thermoplastic Resin Composition

Aspects of the disclosure relate to thermoplastic composition comprising at least one crystalline or semi-crystalline polyester, an amorphous resin, and a reinforcing filler. In certain aspects, the thermoplastic composition may comprise a recycled resin or additional component, such as a recycled crystalline or semi-crystalline polyester, a recycled amorphous resin, a recycled filler or a combination thereof.

In various aspects, the present disclosure provides composite materials or compositions useful for the manufacture of enclosures that can help transmit microwave electromagnetic energy. These materials have been evaluated for dielectric properties at frequencies from about 1 GHZ and 100 GHz.

Further disclosed is a component of an automotive radar sensor, such as, for example, a plate, enclosure, or cover, which is molded from a material comprising a crystalline or semi-crystalline polymer, an amorphous polymer and a filler, with the molded part having certain design, average thickness, microwave transmission efficiency, transmission bandwidth. Still another aspect of the present disclosure is an article, such as, for example, a radar sensor, camera, electronic control unit ECU, comprising a molded part made from a radar transmitting material. Automotive radar sensors for lane-change assistance, self-parking, blind spot detection and collision avoidance typically operate at 24 GHz of frequency; those for adaptive cruise control operate at 77 GHz frequency. Accordingly, composition of the present disclosure may be applied the K-band, which includes the 24 GHz frequency, and in the W-band, which includes the 77 GHz frequency.

### Crystalline or Semi-Crystalline Polymer

In various aspects, the disclosed composition may comprise at least one crystalline or semi-crystalline polyester. Crystallinity, or semi-crystallinity, of a polymer may describe a polymer having molecular chains that are organized or more tightly packed. A result, this highly organized molecular structure may provide a more a defined melting point. These polymers are anisotropic in flow, so they exhibit greater shrinkage transverse to flow rather than with the flow, which can sometimes result in some dimensional instability. There can be varying degrees of crystallinity among different materials and as well as variations among of the same material. The degree of crystallinity can affect many characteristics of the polymer. Molecular weight and branching may affect crystallinity.

The at least one crystalline or semi-crystalline polyester includes polybutylene terephthalate (PBT), polycyclohexylene dimethylene terephthalate (PCT), polyethylene terephthalate (PET), polyethylene terephthalate glycol (PETG), polycyclohexylene dimethylene terephthalate glycol (PCTG), polycyclohexylene dimethylene terephthalate acid (PCTA), copolymers thereof, or a combination thereof. In a particular aspect the at least one crystalline or semi-crystalline polyester includes polybutylene terephthalate (PBT).

In various aspects of the present disclosure, the thermoplastic resin may comprise a crystalline or semi-crystalline polyester. For example, the thermoplastic resin may comprise a polyalkylene ester (a polyester), such as a polyalkylene terephthalate polymer.

Polyesters have repeating units of the following formula (A):

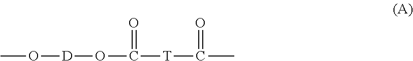

wherein T is a residue derived from a terephthalic acid or chemical equivalent thereof, and D is a residue derived from polymerization of an ethylene glycol, butylene diol, specifically 1,4-butane diol, or chemical equivalent thereof. Chemical equivalents of diacids include dialkyl esters, for example, dimethyl esters, diaryl esters, anhydrides, salts, acid chlorides, acid bromides, and the like. Chemical equivalents of ethylene diol and butylene diol include esters, such as dialkylesters, diaryl esters, and the like. In addition to units derived from a terephthalic acid or chemical equivalent thereof, and ethylene glycol or a butylene diol, specifically 1,4-butane diol, or chemical equivalent thereof, other T and/or D units can be present in the polyester, provided that the type or amount of such units do not significantly adversely affect the desired properties of the thermoplastic compositions. Poly(alkylene arylates) can have a polyester structure according to formula (A), wherein T comprises groups derived from aromatic dicarboxylates, cycloaliphatic dicarboxylic acids, or derivatives thereof.

Examples of specifically useful T groups include, but are not limited to, 1,2-,1,3-, and 1,4-phenylene; 1,4- and 1,5-naphthylenes; cis- or trans-1,4-cyclohexylene; and the like. Specifically, where T is 1,4-phenylene, the poly(alkylene arylate) is a poly(alkylene terephthalate). In addition, for poly(alkylene arylate), specifically useful alkylene groups D include, for example, ethylene, 1,4-butylene, and bis-(alkylene-disubstituted cyclohexane) including cis- and/or trans-1,4-(cyclohexylene)dimethylene.

Examples of polyalkylene terephthalate include polyethylene terephthalate (PET), poly(1,4-butylene terephthalate) (PBT), and poly(propylene terephthalate) (PPT). Also useful are poly(alkylene naphthoates), such as poly(ethylene naphthanoate) (PEN), and poly(butylene naphthanoate) (PBN). A useful poly(cycloalkylene diester) is poly(cyclohexanedimethylene terephthalate) (PCT). Combinations including at least one of the foregoing polyesters may also be used.

Copolymers including alkylene terephthalate repeating ester units with other ester groups can also be useful. Useful ester units can include different alkylene terephthalate units, which can be present in the polymer chain as individual units, or as blocks of poly(alkylene terephthalates). Specific examples of such copolymers include poly(cyclohexanedimethylene terephthalate)-co-poly(ethylene terephthalate), abbreviated as PETG where the polymer includes greater than or equal to 50 mol % of poly(ethylene terephthalate), and abbreviated as PCTG where the polymer comprises greater than 50 mol % of poly(1,4-cyclohexanedimethylene terephthalate). Poly(cycloalkylene diester)s can also include poly(alkylene cyclohexanedicarboxylate)s. Of these, a specific example is poly(1,4-cyclohexane-dimethanol-1,4-cyclohexanedicarboxylate) (PCCD), having recurring units of formula (B):

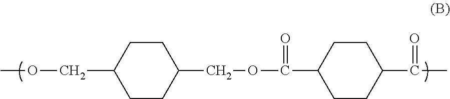

wherein, as described using formula (A), R² is a 1,4-cyclohexanedimethylene group derived from 1,4-cyclohexanedimethanol, and T is a cyclohexane ring derived from cyclohexanedicarboxylate or a chemical equivalent thereof, and can comprise the cis-isomer, the trans-isomer, or a combination comprising at least one of the foregoing isomers.

In another aspect, the composition can further comprise poly(1,4-butylene terephthalate) or “PBT” resin. PBT may be obtained by polymerizing a glycol component of which at least 70 mol %, preferably at least 80 mol %, consists of tetramethylene glycol and an acid or ester component of which at least 70 mol %, preferably at least 80 mol %, consists of terephthalic acid and/or polyester-forming derivatives thereof. Commercial examples of PBT include those available under the trade names VALOX™ 315, VALOX™ 195 and VALOX™ 176, manufactured by SABIC™, having an intrinsic viscosity of 0.1 deciliters per gram (dl/g) to about 2.0 dl/g (or 0.1 dl/g to 2 dl/g) as measured in a 60:40 phenol/tetrachloroethane mixture or similar solvent at 23 degrees Celsius (° C.) to 30° C. In one aspect, the PBT resin has an intrinsic viscosity of 0.1 dl/g to 1.4 dl/g (or about 0.1 dl/g to about 1.4 dl/g), specifically 0.4 dl/g to 1.4 dl/g (or about 0.4 dl/g to about 1.4 dl/g).

In certain aspects, the crystalline or semi-crystalline polyester may have a refractive index value that is less than the refractive index of the reinforcing filler present in the composition. As a specific example, the crystalline or semi-crystalline polyester may have a refractive index that is less than the refractive index of glass where glass filler is employed as the reinforcing filler. The crystalline or semi-crystalline polyester may have a refractive index that is at least 1%, at least 2%, at least 5%, at least 10%, at least 15%, or at least 20% less than the refractive index of glass or glass filler or a glass fiber filler. The amorphous resin may have refractive index higher than that of glass. In some aspects, the amorphous resin may refractive index higher than 1.5, or greater than 1.55, or greater than 1.6.

As described herein, the composition may comprise from about 10 wt. % to about 87 wt. % of a crystalline or semi-crystalline polyester. In further examples, the composition may comprise from about 50 wt. % to about 80 wt. % of a crystalline or semi-crystalline polyester, from about 45 wt. % to about 79 wt. % of a crystalline or semi-crystalline polyester, from about 35 wt. % to about 80 wt. % of a crystalline or semi-crystalline polyester, from about 45 wt. % to about 65 wt. % of a crystalline or semi-crystalline polyester, from about 40 wt. % to about 70 wt. % of a crystalline or semi-crystalline polyester, or from about 50 wt. % to about 97 wt. % of a crystalline or semi-crystalline polyester, or from about 40 wt. % to about 97 wt. % of a crystalline or semi-crystalline polyester, or from about 55 wt. % to about 97 wt. % of a crystalline or semi-crystalline polyester, or from about 60 wt. % to about 97 wt. % of a crystalline or semi-crystalline polyester, or from about 70 wt. % to about 97 wt. % of a crystalline or semi-crystalline polyester, or from about 40 wt. % to about 95 wt. % of a crystalline or semi-crystalline polyester, or from about 55 wt. % to about 95 wt. % of a crystalline or semi-crystalline polyester, or from about 60 wt. % to about 95 wt. % of a crystalline or semi-crystalline polyester.

### Amorphous Resin

In an aspect, the thermoplastic composition may comprise a combination of at least one crystalline or semi-crystalline polyester and an amorphous resin. An amorphous polymer resin may describe a polymer resin have a randomly ordered molecular structure and may lack a discrete melting point. Such amorphous materials may gradually soften as temperature increases. The amorphous resin is often characterized according to its glass transition temperature, T_{g}. While crystalline and to some extent semi-crystalline polymers exhibit organized and tightly packed molecular chains, the polymer chains for amorphous plastics are more disorganized.

The composition may comprise from about 3 wt. % to about 45 wt. % of an amorphous resin. The composition may comprise from about 4 wt. % to about 40 wt. % of an amorphous resin, or from about 5 wt. % to about 47 wt. % of an amorphous resin, or from about 3 wt. % to about 47 wt. % of an amorphous resin, or from about 8 wt. % to about 40 wt. % of an amorphous resin, or from about 8 wt. % to about 45 wt. % of an amorphous resin, or from about 3 wt. % to about 41 wt. % of an amorphous resin, or from about 3 wt. % to about 50 wt. % of an amorphous resin, or from about 60 wt. % to about 95 wt. % of an amorphous resin.

In certain aspects, the amorphous resin may have a refractive index value that is greater than the refractive index of the reinforcing filler present in the composition. As a specific example, the amorphous resin may have a refractive index that is higher than the refractive index of glass where glass filler is employed as the reinforcing filler. The amorphous resin may have a refractive index that is at least 1%, at least 2%, at least 5%, at least 10%, at least 15%, or at least 20% greater than the refractive index of glass or glass filler or a glass fiber filler. The amorphous resin may have refractive index higher than that of glass. In some aspects, the amorphous resin may refractive index higher than 1.5, or greater than 1.55, or greater than 1.6.

The amorphous resin may comprise a polyetherimide PEI, a copolymer PEI, a polycarbonate, a copolymer polycarbonate, a polyphenylene ether PPE, a copolymer PPE, a polyphenylene oxide PPO, or a combination thereof.

In certain aspects, the amorphous resin may have a dissipation factor value that is less than the dissipation factor of the crystalline or semi-crystalline polymer in the composition. The amorphous resin may exhibit a dissipation factor that is at least 1%, at least 2%, at least 5%, at least 10%, at least 15%, or at least 20% less than the dissipation factor of the crystalline or semi-crystalline polyester. In some aspects, the amorphous resin may exhibit a dissipation factor lower than 0.01, or lower than 0.005.

The amorphous resin may comprise a polycarbonate, a polycarbonate copolymer (such as a polycarbonate copolymer DMX), a polyphenylene ether PPE, a PPE copolymer, a polyphenylene oxide PPO, a polyetherimide PEI, a PEI copolymer, or a combination thereof.

In further aspects, the thermoplastic resin may comprise an amorphous resin, such as a polycarbonate polymer. A polycarbonate can include any polycarbonate material or mixture of materials, for example, as recited in U.S. Pat. No. 7,786,246, which is hereby incorporated in its entirety for the specific purpose of disclosing various polycarbonate compositions and methods. The term polycarbonate can be further defined as compositions having repeating structural units of the formula (1):

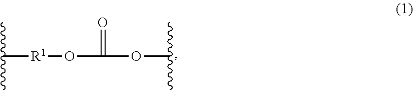

in which at least 60 percent of the total number of R¹ groups are aromatic organic radicals and the balance thereof are aliphatic, alicyclic, or aromatic radicals. In a further aspect, each R¹ is an aromatic organic radical and, more preferably, a radical of the formula (2):

-A¹-Y¹-A²- (2),

wherein each of A¹ and A² is a monocyclic divalent aryl radical and Y¹ is a bridging radical having one or two atoms that separate A¹ from A². In various aspects, one atom separates A¹ from A². For example, radicals of this type include, but are not limited to, radicals such as −O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ is preferably a hydrocarbon group or a saturated hydrocarbon group such as methylene, cyclohexylidene, or isopropylidene.

In various further aspects, “polycarbonates” and “polycarbonate resins” as used herein further include homopolycarbonates, copolymers including different R¹ moieties in the carbonate (referred to herein as “copolycarbonates”), copolymers including carbonate units and other types of polymer units, such as ester units, polysiloxane units, and combinations including at least one of homopolycarbonates and copolycarbonates. As used herein, “combination” is inclusive of blends, mixtures, alloys, reaction products, and the like.

In specific examples, the amorphous resin may comprise a polycarbonate copolymer DMX. DMX describes a dimethyl bis phenol cyclohexane (DMBPC)-co-PBA polycarbonate according to the following formula:

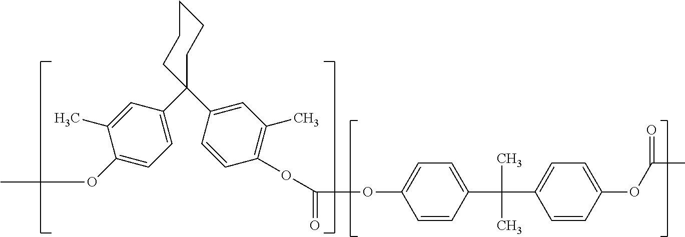

The amorphous resin may comprise a polyphenylene oxide (a “poly(p-phenylene oxide).” PPO may describe polymers containing optionally substituted phenyl rings linked with oxygen (O) and can be used interchangeably with poly(p-phenylene ether) or poly (2,6 dimethyl-p-phenylene oxide). Poly(p-phenylene oxide) may be included by itself or may be blended with other polymers, including but not limited to polystyrene, high impact styrene-butadiene copolymer and/or polyamide. A siloxane-PPO copolymer (or PPO-Siloxane) copolymer may be useful in aspects of the present disclosure. The incorporation of siloxane building blocks may provide PPO additional features like flame retardant, low smoke, high impact strength.

The amorphous resin may comprise a polyetherimide. Polyetherimides (“PEIs”) are amorphous, transparent, high performance polymers having a glass transition temperature (“T_{g}”) of greater than 180° C. In an aspect, polyetherimides can comprise polyetherimides homopolymers (for example, polyetherimidesulfones) and polyetherimides copolymers. The polyetherimide can be selected from (i) polyetherimide homopolymers, e.g., polyetherimides, (ii) polyetherimide co-polymers, and (iii) combinations thereof. Polyetherimides are known polymers and are sold by SABIC under the ULTEM™, EXTEM™, and SILTEM™ brands.

In an aspect, the polyetherimides can be of formula (1):

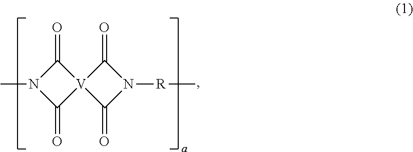

wherein a is more than 1, for example 10 to 1,000 or more, or more specifically 10 to 500.

The group V in formula (1) is a tetravalent linker containing an ether group (a “polyetherimide” as used herein) or a combination of an ether groups and arylenesulfone groups (a “polyetherimidesulfone”). Such linkers include but are not limited to: (a) substituted or unsubstituted, saturated, unsaturated or aromatic monocyclic and polycyclic groups having 5 to 50 carbon atoms, optionally substituted with ether groups, arylenesulfone groups, or a combination of ether groups and arylenesulfone groups; and (b) substituted or unsubstituted, linear or branched, saturated or unsaturated alkyl groups having 1 to 30 carbon atoms and optionally substituted with ether groups or a combination of ether groups, arylenesulfone groups, and arylenesulfone groups; or combinations comprising at least one of the foregoing. Suitable additional substitutions include, but are not limited to, ethers, amides, esters, and combinations comprising at least one of the foregoing.

The R group in formula (1) includes but is not limited to substituted or unsubstituted divalent organic groups such as: (a) aromatic hydrocarbon groups having 6 to 20 carbon atoms and halogenated derivatives thereof; (b) straight or branched chain alkylene groups having 2 to 20 carbon atoms; (c) cycloalkylene groups having 3 to 20 carbon atoms, or (d) divalent groups of formula (2):

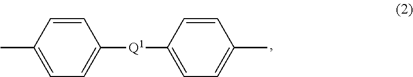

wherein Q1 includes but is not limited to a divalent moiety such as —O—, —S—, —C(O)—, —SO2-, —SO—, -CyH2y-(y being an integer from 1 to 5), and halogenated derivatives thereof, including perfluoroalkylene groups.

In yet further aspects, the thermoplastic composition may comprise a recycled thermoplastic, such as a post-consumer or post-industrial recycled thermoplastic resin ((collectively referred to herein as “PCR”). More specifically, the composition may comprise a recycled polyester resin. As used herein, the term “post-consumer recycled PET,” or “recycled PET,” or “postindustrial recycled PET” refers to a recycled PET that comprises at least one impurity not present in a corresponding, substantially similar or identical virgin PET. The PET may be reclaimed from post-consumer sources, including but not limited to, home appliances waste for example TV, air-conditioners, washing machines, refrigerators, and like. Irrespective of the source, the recycled PET component can be similar or even identical to those virgin plastic components, known as impact modifier components, that are conventionally used in the manufacture of impact modified thermoplastic blend compositions. However, an important difference between virgin plastic components and recycled plastics utilized in the present compositions, it the presence of at least one impurity that is not present in a virgin material. For example, one or more additives conventionally used in the manufacture of impact modified thermoplastics can be present as an impurity. Additional impurities can include processing residues such as lubricants, mold release agents, antistatic agents, stabilizers, light stabilizers, flame retardants, metals (e.g. iron, aluminum, and copper). Still further, the impurities can include polyurethane particles that cannot be fully removed during the recycling process.

### Reinforcing Filler

In various aspects, the composition comprises a reinforcing filler. Suitable reinforcing filler components may include for example, mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates) talc (including fibrous, modular, needle shaped, and lamellar talc), wollastonite, hollow or solid glass spheres, silicate spheres, cenospheres, aluminosilicate or (armospheres), kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, titanium dioxide TiO₂, aluminum oxide, magnesium oxide, particulate or fibrous aluminum, bronze, zinc, copper, or nickel, glass flakes, flaked silicon carbide, flaked aluminum diboride, flaked aluminum, steel flakes, natural fillers such as wood flour, fibrous cellulose, cotton, sisal, jute, starch, lignin, ground nut shells, or rice grain husks, reinforcing organic fibrous fillers such as poly(ether ketone), polyimide, polybenzoxazole, poly(phenylene sulfide), polyesters, polyethylene, aromatic polyamides, aromatic polyimides, polyetherimides, polytetrafluoroethylene, and poly(vinyl alcohol), as well combinations comprising at least one of the foregoing fillers or reinforcing agents. The fillers and reinforcing agents may be coated with a layer of metallic material to facilitate conductivity, or surface treated, with silanes for example, to improve adhesion and dispersion with the polymer matrix. In various aspects, the selected reinforcing filler may exhibit a refractive index lower than that of the amorphous resin, and/or higher than that of the crystalline or semi-crystalline polymer employed in the present disclosure.

In specific aspects, suitable reinforcing filler comprises glass, such as glass fibers. In some examples, the glass fiber may be selected from E-glass, S-glass, AR-glass, T-glass, D-glass, R-glass, and combinations thereof. In some examples, the glass fibers may comprise E-glass (modulus below 85 GPa), S-glass (modulus above 85 GPa), low dk glass (dk less than 5 or df less than 0.002, or comprising at least 90% the combination of silicon dioxide and boron oxide), or a combination thereof.

The E-glass may refer to a glass fiber having a tensile modulus 70-85 GPa, a tensile strength 2-4 GPa. The E-glass may also refer to a glass fiber comprising 52-62 wt. % silicon dioxide, 12-16 wt. % aluminum oxide, 16-25 wt. % calcium oxide, 0-10 wt. % boron oxide, 0-5 wt. % magnesium oxide, and 0-5 wt. % other components.

The S-glass may refer to a glass fiber having tensile modulus above 85 GPa, tensile strength above 4 GPa. The S-glass may also refer to a glass fiber comprising 57-70 wt. % silicon dioxide, 18-30 wt. % aluminum oxide, 0-10 wt. % calcium oxide, 0-5 wt. % boron oxide, 7-15 wt. % magnesium oxide, 0-5 wt. % other components.

The Low Dk glass may refer to a glass fiber having a dielectric constant lower than 5 and/or a dissipation factor lower than 0.002, at a frequency of from 1 GHz to 100 GHz (or from 1 MHz to 100 GHz, or from about 1-20 GHz, 1-25 GHz, 1-100 GHZ, 50-100 GHz, or 70-90 GHz) when measured according to a resonant cavity method. Dielectric properties including Dk and Df may be measured according to any appropriate method. According to various aspects, such dielectric properties may be measured according to a resonant cavity method, where a hollow metal box is used to measure the properties at microwave frequencies. The Low Dk glass may also refer to a glass fiber comprising at least 90% the combination of silicon dioxide and boron oxide.

The glass fibers used in select aspects of this disclosure may be surface-treated with a surface treatment agent containing a coupling agent to improve adhesion to the polymer base resin. Suitable coupling agents can include, but are not limited to, silane-based coupling agents, titanate-based coupling agents or a mixture thereof. Applicable silane-based coupling agents include aminosilane, epoxysilane, amidesilane, azidesilane and acrylsilane. Organo-metallic coupling agents, for example, titanium or zirconium-based organo-metallic compounds, may also be used.

The glass fiber may have a variety of shapes. The glass fiber may include milled or chopped glass fibers. The glass filler may be in the form of whiskers or flakes. In further examples, the glass fiber may be short glass fiber or long glass fiber. Low dielectric constant glass fibers having a length of about 4 mm or longer are referred as to long fibers, and fibers shorter than this are referred to as short fibers. In one aspect, the diameter of the glass fibers can be about 10 μm.

The glass fibers may have a circular cross section, or a non-circular cross section, or a mixture of the above. The non-circular cross section may have an axial ratio in the range of 1.5 to 8, or more specifically 3 to 5. In a yet further aspect, the diameter of the glass fiber is from about 1 to about 15 μm. More specifically, the diameter of the glass fiber may be from about 4 to about 10 μm.

In some aspects, the composition can comprise from about 10 wt. % to about 70 wt. % of a reinforcing filler based on the total weight of the polymer composition. In further examples, the composition may comprise from about 10 wt. % to about 69 wt. % of a reinforcing filler. The composition may comprise from about 8 wt. % to about 70 wt. % of a reinforcing filler, or from about 8 wt. % to about 69 wt. % of a reinforcing filler, or from about 10 wt. % to about 65 wt. % of a reinforcing filler, or from about 8 wt. % to about 65 wt. % of a reinforcing filler, or from about 10 wt. % to about 68 wt. % of a reinforcing filler, such as the disclosed glass fiber.

### Impact Modifier

In further aspects of the present disclosure, the composition can comprise a rubbery impact modifier. The rubber impact modifier can be a polymeric material which, at room temperature, is capable of recovering substantially in shape and size after removal of a force. However, the rubbery impact modifier should typically have a glass transition temperature of less than 0° C. In certain aspects, the glass transition temperature (T_{g}) can be less than ˜5° C., −10° C., −15° C., with a T_{g} of less than ˜30° C. typically providing better performance. Representative rubbery impact modifiers can include, for example, functionalized polyolefin ethylene-acrylate terpolymers, such as ethylene-acrylic esters-maleic anhydride (MAH) or glycidyl methacrylate (GMA). The functionalized rubbery polymer can optionally contain repeat units in its backbone which are derived from an anhydride group containing monomer, such as maleic anhydride. In another scenario, the functionalized rubbery polymer can contain anhydride moieties which are grafted onto the polymer in a post polymerization step.

Other impact modifiers may include styrene-butadiene-styrene (SBS), styrene-butadiene rubber (SBR), styrene-ethylene-butadiene-styrene (SEBS), styrene ethylene propylene styrene (SEPS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN). An example SEBS impact modifier is high flow SEBS with a melt flow index that is greater than 3 g/10 min at 230° C./5 kg. In some examples, the composition may comprise an impact modifier or a mixture of impact modifiers as selected from polyolefin-acrylate, ethylene-glycidyl methacrylate, ethylene-methyl acrylate-glycidyl methacrylate, ethylene acrylate copolymer, styrene-butadiene-styrene (SBS), styrene-ethylene/1-butene-styrene block copolymer (SEBS), styrene-ethylene-propylene-styrene (SEPS).

Impact modifiers may be included in the present composition in the amount of 0 to about 10 wt. % or 0.01 to about 10 wt. % based on the total composition. For example, the impact modifier may be present in the amount of 0.01-5 wt. %, 7-20 wt. %, 8-16 wt. %, 9-15 wt. %, or 9-12 wt. %, for example, in the amount of about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, or about 25 wt. %.

### Additives

The disclosed thermoplastic composition can comprise one or more additives conventionally used in the manufacture of molded thermoplastic parts with the proviso that the optional additives do not adversely affect the desired properties of the resulting composition. Mixtures of optional additives can also be used. Such additives can be mixed at a suitable time during the mixing of the components for forming the composition mixture. Exemplary additives can include ultraviolet agents, ultraviolet stabilizers, heat stabilizers, antistatic agents, anti-microbial agents, anti-drip agents, radiation stabilizers, pigments, dyes, fibers, fillers, plasticizers, fibers, flame retardants, antioxidants, lubricants, wood, glass, metals, colorants, and combinations thereof.

According to certain aspects, the polymer compositions may maintain mechanical performance and dielectric properties even with high levels of fillers (for example, greater than 30 wt. % filler based on the total weight of the polymer composition).

The compositions disclosed herein can comprise one or more additional fillers. The filler can be selected to impart additional impact strength and/or provide additional characteristics that can be based on the final selected characteristics of the polymer composition. In some aspects, the filler(s) can comprise inorganic materials which can include clay, titanium oxide, asbestos fibers, silicates and silica powders, boron powders, calcium carbonates, talc, kaolin, sulfides, barium compounds, metals and metal oxides, wollastonite, glass spheres, glass fibers, flaked fillers, fibrous fillers, natural fillers and reinforcements, and reinforcing organic fibrous fillers. In certain aspects, the composition may comprise a glass fiber filler.

Appropriate fillers or reinforcing agents can include, for example, mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates) talc (including fibrous, modular, needle shaped, and lamellar talc), wollastonite, hollow or solid glass spheres, silicate spheres, cenospheres, aluminosilicate or (armospheres), kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, titanium dioxide, aluminum oxide, magnesium oxide, particulate or fibrous aluminum, bronze, zinc, copper, or nickel, glass flakes, flaked silicon carbide, flaked aluminum diboride, flaked aluminum, steel flakes, natural fillers such as wood flour, fibrous cellulose, cotton, sisal, jute, starch, lignin, ground nut shells, or rice grain husks, reinforcing organic fibrous fillers such as poly(ether ketone), polyimide, polybenzoxazole, poly(phenylene sulfide), polyesters, polyethylene, aromatic polyamides, aromatic polyimides, polyetherimides, polytetrafluoroethylene, and poly(vinyl alcohol), as well combinations comprising at least one of the foregoing fillers or reinforcing agents. The fillers and reinforcing agents can be coated or surface treated, with silanes for example, to improve adhesion and dispersion with the polymer matrix. Fillers generally can be used in amounts of 1 to 200 parts by weight, based on 100 parts by weight of based on 100 parts by weight of the total composition.

In some aspects, the thermoplastic composition may comprise a synergist. In various examples fillers may serve as flame retardant synergists. The synergist facilitates an improvement in the flame retardant properties when added to the flame retardant composition over a comparative composition that contains all of the same ingredients in the same quantities except for the synergist. Examples of mineral fillers that may serve as synergists are mica, talc, calcium carbonate, dolomite, wollastonite, barium sulfate, silica, kaolin, feldspar, barytes, or the like, or a combination comprising at least one of the foregoing mineral fillers. Metal synergists, e.g., antimony oxide, can also be used with the flame retardant. In one example, the synergist may comprise magnesium hydroxide and phosphoric acid. The mineral filler may have an average particle size of about 0.1 to about 20 micrometers, specifically about 0.5 to about 10 micrometers, and more specifically about 1 to about 3 micrometers.

The thermoplastic composition can comprise an antioxidant. The antioxidants can include either a primary or a secondary antioxidant. For example, antioxidants can include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations including at least one of the foregoing antioxidants. Antioxidants can generally be used in amounts of from 0.01 to 0.5 parts by weight, based on 100 parts by weight of the total composition, excluding any filler.

In various aspects, the thermoplastic composition can comprise a mold release agent. Exemplary mold releasing agents can include for example, metal stearate, stearyl stearate, pentaerythritol tetrastearate, beeswax, montan wax, paraffin wax, or the like, or combinations including at least one of the foregoing mold release agents. Mold releasing agents are generally used in amounts of from about 0.1 to about 1.0 parts by weight, based on 100 parts by weight of the total composition, excluding any filler.

In an aspect, the thermoplastic composition can comprise a heat stabilizer. As an example, heat stabilizers can include, for example, organo-phosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations including at least one of the foregoing heat stabilizers. Heat stabilizers can generally be used in amounts of from 0.01 to 0.5 parts by weight based on 100 parts by weight of the total composition, excluding any filler.

In further aspects, light stabilizers can be present in the thermoplastic composition. Exemplary light stabilizers can include, for example, benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone or the like or combinations including at least one of the foregoing light stabilizers. Light stabilizers can generally be used in amounts of from about 0.1 to about 1.0 parts by weight, based on 100 parts by weight of the total composition, excluding any filler.

The thermoplastic composition can also comprise plasticizers. For example, plasticizers can include phthalic acid esters such as dioctyl-4,5-epoxy-hexahydrophthalate, tris-(octoxycarbonylethyl) isocyanurate, tristearin, epoxidized soybean oil or the like, or combinations including at least one of the foregoing plasticizers. Plasticizers are generally used in amounts of from about 0.5 to about 3.0 parts by weight, based on 100 parts by weight of the total composition, excluding any filler.

Ultraviolet (UV) absorbers can also be present in the disclosed thermoplastic composition. Exemplary ultraviolet absorbers can include for example, hydroxybenzophenones; hydroxybenzotriazoles; hydroxybenzotriazines; cyanoacrylates; oxanilides; benzoxazinones; 2-(2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4-phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3, 3-diphenylacryloyl)oxy]methyl]propane (UVINUL™ 3030); 2,2′-(1,4-phenylene) bis(4H-3,1-benzoxazin-4-one); 1,3-bis[(2-cyano-3,3-diphenylacryloyl)oxy]-2,2-bis[[2-cyano-3,3-diphenylacryloyl)oxy]methyl]propane; nano-size inorganic materials such as titanium oxide, cerium oxide, and zinc oxide, all with particle size less than 100 nanometers; or the like, or combinations including at least one of the foregoing UV absorbers. UV absorbers are generally used in amounts of from 0.01 to 3.0 parts by weight, based on 100 parts by weight of the total composition, excluding any filler.

The thermoplastic composition can further comprise a lubricant. As an example, lubricants can include for example, fatty acid esters such as alkyl stearyl esters, e.g., methyl stearate or the like; mixtures of methyl stearate and hydrophilic and hydrophobic surfactants including polyethylene glycol polymers, polypropylene glycol polymers, and copolymers thereof e.g., methyl stearate and polyethylene-polypropylene glycol copolymers in a suitable solvent; or combinations including at least one of the foregoing lubricants. Lubricants can generally be used in amounts of from about 0.1 to about 5 parts by weight, based on 100 parts by weight of the total composition, excluding any filler.

Anti-drip agents can also be used in the composition, for example a fibril forming or non-fibril forming fluoropolymer such as polytetrafluoroethylene (PTFE). The anti-drip agent can be encapsulated by a rigid copolymer, for example styrene-acrylonitrile copolymer (SAN). PTFE encapsulated in SAN is known as TSAN. In one example, TSAN can comprise 50 wt. % PTFE and 50 wt. % SAN, based on the total weight of the encapsulated fluoropolymer. The SAN can comprise, for example, 75 wt. % styrene and 25 wt. % acrylonitrile based on the total weight of the copolymer. An antidrip agent, such as TSAN, can be used in amounts of 0.1 to 10 parts by weight, based on 100 parts by weight of the total composition, excluding any filler.

As an example, the disclosed composition can comprise an impact modifier. The impact modifier can be a chemically reactive impact modifier. By definition, a chemically reactive impact modifier can have at least one reactive group such that when the impact modifier is added to a polymer composition, the impact properties of the composition (expressed in the values of the Izod impact) are improved. In some examples, the chemically reactive impact modifier can be an ethylene copolymer with reactive functional groups selected from, but not limited to, anhydride, carboxyl, hydroxyl, and epoxy.

The composition may comprise one colorant or a mixture of colorants as selected from organic dyes, inorganic colorants. The inorganic colorants may comprise one or more inorganic elements as selected from carbon, titanium, zinc, sodium, magnesium, calcium, aluminum.

### Properties and Articles

In certain aspects, the disclosed composition may exhibit certain dielectric, warpage and optical transmission properties. A molded article or plaque comprising the composition may exhibit a dissipation factor (Df) of from about 0.001 to about 2 when determined as a ratio of a″ and a′ at frequencies from 1-90 GHz when measured according to a resonant cavity method. The composition may exhibit a higher light transmission value than the light transmission value observed for a reference composition in the absence of the amorphous resin as determined by UV-VIS-IR method.

Plaques molded from the disclosed composition may exhibit warpage properties. Warpage can be defined as a dimensional distortion in a molded product after it is ejected from the mold at the end of the injection molding process. With an increasing focus on thin-walled products, control over the dimensional stability becomes increasingly important. For example, a molded sample may exhibit lower warpage value in terms of both average value and standard deviation, as determined using the above method, as compared to a comparative composition that does not include the amorphous polymer. In further aspects, warpage may be determined by observing the magnitude (visually or quantitatively) of lift off away from a planar surface at which a molded part comprising the composition is placed. The composition may exhibit a lower warpage than the warpage observed for a reference composition in the absence of the amorphous resin.

Plaques molded from the disclosed composition may exhibit optical transmission properties. With an increasing focus on laser welding assembly of radar covers, the demand for high transmission materials has similarly increased. Percent Transmission as described herein may be measured by a UV-VIS-IR transmission method. For example, a molded sample may exhibit higher transmission value at 900-1100 nm wavelength, which is the range of the laser applications, as compared to a reference composition that does not include the amorphous polymer.

In various aspects, the present disclosure relates to articles comprising the compositions herein. The compositions can be molded into useful shaped articles by a variety of means such as injection molding, extrusion, rotational molding, blow molding and thermoforming to form articles. The compositions can be useful in the manufacture of articles requiring materials with good flow, good flatness, good microwave transmission and optical transmission properties. The advantageous characteristics of the compositions disclosed herein make them appropriate for an array of uses. In various aspects, the present disclosure provides materials useful for the manufacture of enclosures that can transmit microwave electromagnetic energy. Further disclosed herein are radar sensor components (plates, enclosures, covers, for example) manufactured from these materials, and articles (sensors, cameras, ECUs) manufactured from these components.

### Methods of Manufacture

Aspects of the disclosure further relate to methods for making a thermoplastic composition. The one or any foregoing components described herein may be first dry blended with each other, or dry blended with any combination of foregoing components, then fed into an extruder from one or multi-feeders, or separately fed into an extruder from one or multi-feeders. The fillers used in the disclosure may also be first processed into a masterbatch, then fed into an extruder. The components may be fed into the extruder from a throat hopper or any side feeders.

The extruders used in the disclosure may have a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, co-kneaders, disc-pack processors, various other types of extrusion equipment, or combinations including at least one of the foregoing.

The components may also be mixed together and then melt-blended to form the thermoplastic compositions. The melt blending of the components involves the use of shear force, extensional force, compressive force, ultrasonic energy, electromagnetic energy, thermal energy or combinations including at least one of the foregoing forces or forms of energy. The barrel temperature on the extruder during compounding may be set at the temperature where at least a portion of the polymer has reached a temperature greater than or equal to about the melting temperature, if the resin is a crystalline or semi-crystalline organic polymer, or the flow point (for example, the glass transition temperature) if the resin is an amorphous resin.

The mixture including the foregoing mentioned components may be subject to multiple blending and forming steps if desirable. For example, the thermoplastic composition may first be extruded and formed into pellets. The pellets may then be fed into a molding machine where it may be formed into any desirable shape or product. Alternatively, the thermoplastic composition emanating from a single melt blender may be formed into sheets or strands and subjected to post-extrusion processes such as annealing, uniaxial or biaxial orientation.

The temperature of the melt in the present process may in some aspects be maintained as low as possible in order to avoid excessive thermal degradation of the components. In certain aspects the melt temperature is maintained between about 230° C. and about 350° C., although higher temperatures can be used provided that the residence time of the resin in the processing equipment is kept relatively short. In some aspects the melt processed composition exits processing equipment such as an extruder through small exit holes in a die. The resulting strands of molten resin may be cooled by passing the strands through a water bath. The cooled strands can be chopped into pellets for packaging and further handling.

Methods may further comprise processing the composition to provide a plaque of a desired thickness. Plaques can be extruded, injection molded, compression molded, or injection-compression molded, and may have a thickness between about 0.5 mm and 6 mm. Other processes could also be applied to the thin thermoplastic film, including but not limited to, lamination, co-extrusion, thermo-forming or hot pressing. In such aspects, further layers of other materials (for example, other thermoplastic polymer layers, metallic layers, etc.) could be combined with the composition.

Various combinations of elements of this disclosure are encompassed by this disclosure, for example, combinations of elements from dependent claims that depend upon the same independent claim.

### Definitions

It is also to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims, which follow, reference will be made to a number of terms which shall be defined herein. As used in the specification and the appended claims, the singular forms “a,” “an” and “the” include plural referents unless the context clearly dictates otherwise. Thus, for example, reference to “a thermoplastic polymer component” includes mixtures of two or more thermoplastic polymer components. As used herein, the term “combination” is inclusive of blends, mixtures, alloys, reaction products, and the like.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optional additional processes” means that the additional processes can or cannot be included and that the description includes methods that both include and that do not include the additional processes.

Disclosed are the components to be used to prepare the compositions of the disclosure as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the disclosure. Thus, if there are a variety of additional steps that can be performed it is understood that each of these additional steps can be performed with any specific aspect or combination of aspects of the methods of the disclosure.

References in the specification and concluding aspects to parts by weight of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

The terms “residues” and “structural units”, used in reference to the constituents of the polymers, are synonymous throughout the specification.

In one aspect, “substantially free of” may refer to less than 0.5 wt. % or less than about 0.5 wt. % present in a given composition or component. In another aspect, substantially free of can be less than 0.1 wt. %, or less than about 0.1 wt. %. In another aspect, substantially free of can be less than 0.01 wt. %, or less than about 0.01 wt. %. In yet another aspect, substantially free of can be less than 100 parts per million (ppm), or less than about 100 ppm. In yet another aspect, substantially free can refer to an amount, if present at all, below a detectable level. Substantially free of or free of may further refer to a component that has not been added or incorporated into the composition. For example, the compositions may be free of or substantially free of impact modifier.

In the present application the conventional understanding of “crystalline”, “semi-crystalline” and “amorphous” polymers is used. For example, crystalline polymers are identified as having very high crystallinities (e.g., 95-99%). Crystalline polymers are rigid and have high melting temperatures. They are less affected by solvent penetration. Semi-crystalline polymers may have both crystalline and amorphous regions. Semi-crystalline polymers combine the strength of crystalline polymers with the flexibility of amorphous polymers. Semi-crystalline polymers may be tough with an ability to bend without breaking. Amorphous polymers have polymer chains with branches or irregular groups that cannot pack together regularly enough to form crystals. Amorphous regions of a polymer are made up of a randomly coiled and entangled chains; they softer and have lower melting points than crystalline and semi-crystalline polymers.

As used herein the terms “weight percent,” “wt %,” and “wt. %,” which can be used interchangeably, indicate the percent by weight of a given component based on the total weight of the composition, unless otherwise specified. That is, unless otherwise specified, all wt % values are based on the total weight of the composition. It should be understood that the sum of wt % values for all components in a disclosed composition or formulation is 100.

Unless otherwise stated to the contrary herein, all test standards are the most recent standard in effect at the time of filing this application.

Each of the materials disclosed herein are either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

### Aspects of the Disclosure

In various aspects, the present disclosure pertains to and includes at least the following aspects.

Aspect 1A. A thermoplastic composition comprising: (a) from about 10 wt % to about 87 wt % of at least one crystalline or semi-crystalline polymer, wherein the at least one crystalline polymer comprises a crystalline or semi-crystalline polyester; (b) from about 3 wt % to about 40 wt % of an amorphous polymer resin; (c) from about 10 wt % to about 70 wt % of a reinforcing filler, wherein: the at least one crystalline or semi-crystalline polymer has a lower refractive index value than a refractive index of the reinforcing filler when measured using a refractometer, the amorphous polymer resin has a refractive index value greater than that of the reinforcing filler, the combined weight percent value of all components does not exceed 100 wt %, and all weight percent values are based on the total weight of the composition, and the composition exhibits a dissipation factor Df less than the dissipation factor observed for a reference composition in the absence of the amorphous resin.

Aspect 1C. A thermoplastic composition consisting essentially of: (a) from about 10 wt % to about 87 wt % of at least one crystalline or semi-crystalline polymer, wherein the at least one crystalline or semi-crystalline polymer comprises a crystalline or semi-crystalline polyester; (b) from about 3 wt % to about 40 wt % of an amorphous polymer resin; (c) from about 10 wt % to about 70 wt % of a reinforcing filler, wherein: the at least one crystalline or semi-crystalline polymer has a lower refractive index value than a refractive index of the reinforcing filler when measured using a refractometer, the amorphous polymer resin has a refractive index value greater than that of the reinforcing filler, the combined weight percent value of all components does not exceed 100 wt %, and all weight percent values are based on the total weight of the composition, and the composition exhibits a dissipation factor Df less than the dissipation factor observed for a reference composition in the absence of the amorphous resin.

Aspect 1D. A thermoplastic composition consisting of: (a) from about 10 wt % to about 87 wt % of at least one crystalline or semi-crystalline polymer, wherein the at least one crystalline or semi-crystalline polymer comprises a crystalline or semi-crystalline polyester; (b) from about 3 wt % to about 40 wt % of an amorphous polymer resin; (c) from about 10 wt % to about 70 wt % of a reinforcing filler, wherein: the at least one crystalline or semi-crystalline polymer has a lower refractive index value than a refractive index of the reinforcing filler when measured using a refractometer, the amorphous polymer resin has a refractive index value greater than that of the reinforcing filler, the combined weight percent value of all components does not exceed 100 wt %, and all weight percent values are based on the total weight of the composition.

Aspect 2. The thermoplastic composition according to claim 1, wherein the crystalline or semi-crystalline polyester comprises polybutylene terephthalate (PBT), polycyclohexylene dimethylene terephthalate (PCT), polyethylene terephthalate glycol (PCTG), polycyclohexylene dimethylene terephthalate glycol (PCTG), polycyclohexylene dimethylene terephthalate acid (PCTA), copolymers thereof, or a combination thereof.

Aspect 3. The thermoplastic composition according to claim 1, wherein the crystalline or semi-crystalline polyester comprises polybutylene terephthalate (PBT).

Aspect 4. The thermoplastic composition according to claim 1, wherein the crystalline or semi-crystalline polyester comprises a recycled polybutylene terephthalate.

Aspect 5. The thermoplastic composition according to any one of claims 1-4, wherein the amorphous resin comprises a polycarbonate, a copolymer polycarbonate, a dimethyl bis phenol cyclohexane (DMBPC)-co-PBA polycarbonate, a polyphenylene ether PPE, a polyphenylene oxide, a copolymer PPE, a Polyetherimide PEI, a copolymer PEI, or a combination thereof.

Aspect 6. The thermoplastic composition according to any one of claims 1 to 5, wherein the composition further comprises from about 0.01 wt % to about 10 wt % of at least one impact modifier.

Aspect 7. The thermoplastic composition according to claim 6, wherein the at least one impact modifier comprises polyolefin-acrylate, ethylene-glycidyl methacrylate, ethylene-methyl acrylate-glycidyl methacrylate, ethylene acrylate copolymer, styrene-butadiene-styrene (SBS), styrene-ethylene/1-butene-styrene block copolymer (SEBS), styrene-ethylene-propylene-styrene (SEPS), or a combination thereof.

Aspect 8. The thermoplastic composition according to any one of claims 1-7, wherein the reinforcing filler comprises a glass fiber.

Aspect 9. The thermoplastic composition according to any one of claims 1 to 8, wherein the at least one glass fiber comprises E-glass (modulus below 85 GPa), S-glass (modulus above 85 GPa), low dk glass (dk less than 5, and/or df less than 0.002, and/or comprising at least 90% the combination of silicon dioxide and boron oxide), or a combination thereof.

Aspect 10. The thermoplastic composition according to any one of claims 1 to 9, wherein the at least one glass fiber comprises a circular cross section, a non-circular cross section or a combination thereof. Aspect 11. The thermoplastic composition of any one of claims 1-10, wherein the composition exhibits a lower warpage than the warpage observed for a reference composition in the absence of the amorphous resin for warpage measured as a magnitude of displacement from a flat surface.

Aspect 12. The thermoplastic composition of any one of claims 1-11, wherein the composition exhibits a higher light transmission value than the light transmission value observed for a reference composition in the absence of the amorphous resin when measured using a UV-VIS-IR spectrometer.

Aspect 13. The thermoplastic composition of any one of claims 1-12, wherein the composition exhibits a dissipation factor (Df) of from about 0.001 to about 2 when determined as a ratio of a″ and a′ at frequencies from 1-90 GHz when measured according to a resonant cavity method.

Aspect 14. The thermoplastic composition according to any one of claims 1-13, wherein the composition exhibits a dissipation factor (Df) of from about 0.001 to about 0.02 when determined as a ratio of a″ and a′ at frequencies from 1-100 GHZ when measured according to a resonant cavity method.

Aspect 15. The thermoplastic composition of any one of claims 1-14, further comprising an additive material selected from the group consisting of: an antioxidant; a colorant; a de-molding agent; a dye; a flow promoter; a flow modifier; a light stabilizer; a lubricant; a mold release agent; a pigment; a colorant, a quenching agent; a thermal stabilizer; an ultraviolet (UV) absorbant; a UV reflectant; a UV stabilizer; an epoxy chain extender; a flame retardant; and combinations thereof.

Aspect 16. The thermoplastic composition of any one of claims 1-15, wherein the composition is a component of an automotive radar sensor.

Aspect 17. An article comprising the thermoplastic composition of any one of claims 1-15.

### EXAMPLES

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (for example, amounts, temperature, etc.), but some errors and deviations should be accounted for. Unless indicated otherwise, parts are parts by weight, temperature is in ° C. or is at ambient temperature, and pressure is at or near atmospheric. Unless indicated otherwise, percentages referring to composition are in terms of wt %. There are numerous variations and combinations of mixing conditions, e.g., component concentrations, extruder design, feed rates, screw speeds, temperatures, pressures and other mixing ranges and conditions that can be used to optimize the product purity and yield obtained from the described process. Only reasonable and routine experimentation will be required to optimize such process conditions.

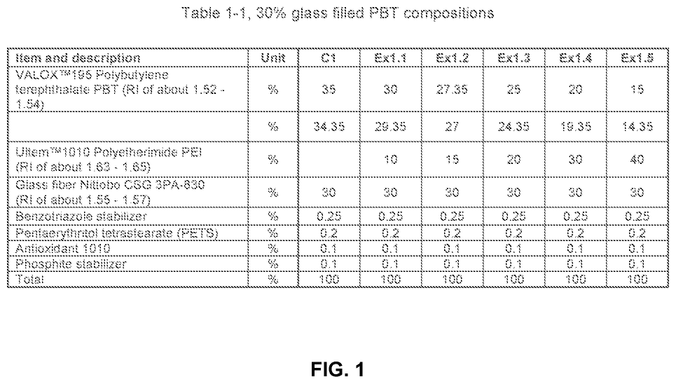

Various PBT composition samples were prepared. Glass-filled PBT examples (30 wt. % glass fiber) are presented in Table 1-1 (FIG. 1). These formulations included amorphous resin PEI, which had a refractive index R¹ of about 1.63 to 1.65 (a value higher than that of glass or glass fiber) when observed using a refractometer (Abbe refractometer or Metricon Model 2010 Prism Coupler) at room temperature. A control formulation included PBT having a R¹ 1.52 to about 1.54, which is lower than that of glass.

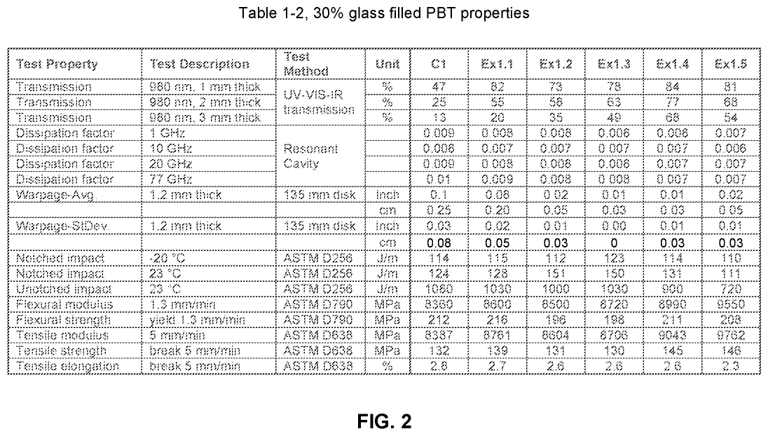

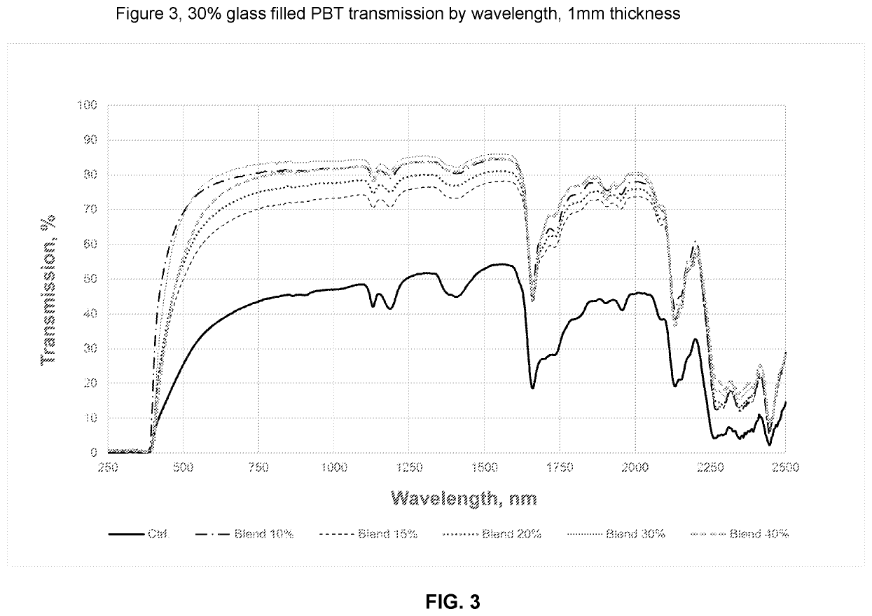

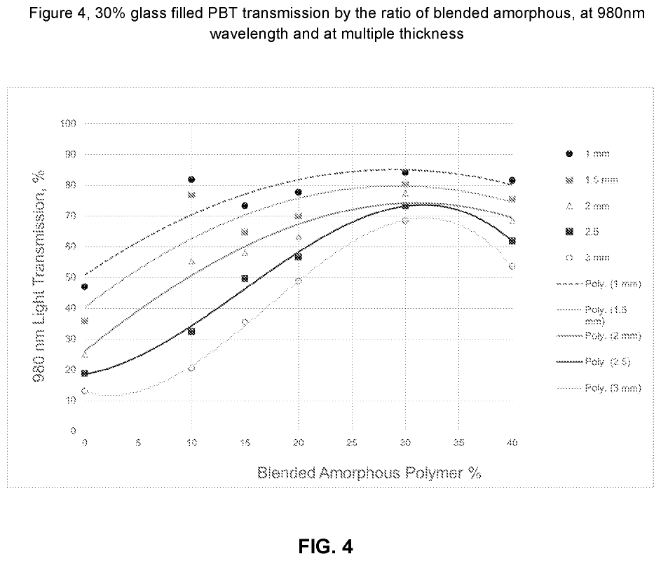

Table 1-2 (FIG. 2) presents the observed properties, and the respective test descriptions and test standards. Optical transmission was determined using UV-VIS-IR spectrometer (Shimadzu UV-3510) at 980 nanometers (nm). Dielectric properties were measured by a resonant cavity method. For frequencies from 1 to 20 GHz, Agilent split resonator was used. The same methodology was used for frequencies 70 to 90 GHz with alternating radio broadcasting frequency. The results of Table 2 demonstrated that using PEI increased the optical transmission, lowed the dissipation factor, lowered warpage values in both average and standard deviation. Good mechanical properties were also observed using PEI. Optical transmission in a broader range of wavelength, 250 to 2500 nm, of the formulations are presented in FIG. 3. This demonstrated a significant increase by blending PEI in PBT. The optical transmission of samples as prepared at varied thickness (1-3 mm) is presented in FIG. 4 and established the consistent increase at different thicknesses.

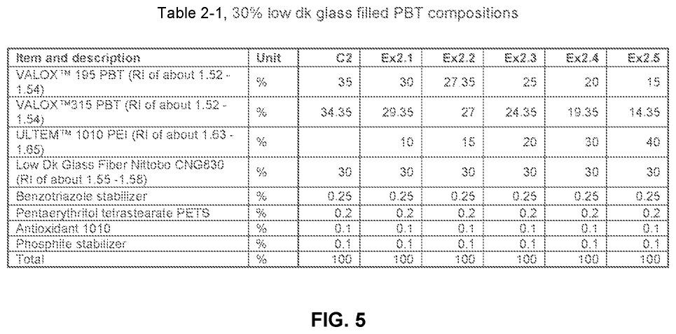

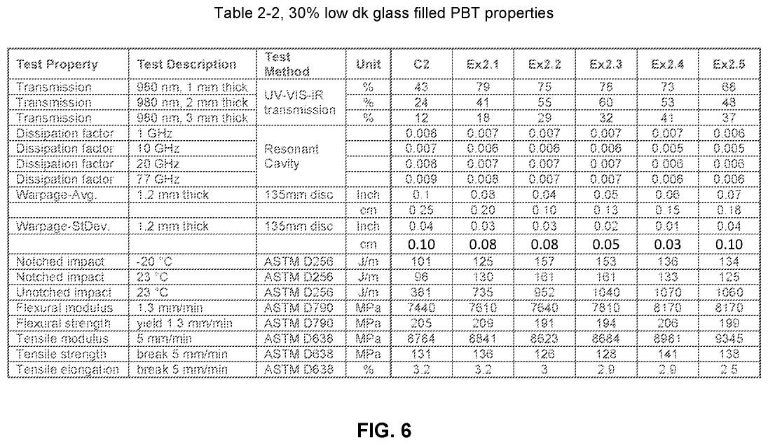

Formulations with a different type of glass fiber, namely, a low dk glass fiber, were also prepared and presented in Table 2-1 (FIG. 5). The R¹ of amorphous resin PEI was higher than that of low dk glass. The control formulation including PBT, which has lower R¹ than that of low dk glass was also prepared. Table 2-2 (FIG. 6) presents the observed properties and respective test standards. Dielectric properties were measured by resonant cavity method. For frequencies from 1 to 20 GHz, Agilent resonant split instrument was used. The same methodology was used for frequencies 70 to 90 GHz with alternating radio broadcasting frequency.

Warpage was be measured on a molded sample disk having 135 mm diameter and 1.2 mm thickness according to an internal method. The disk was placed on a flat surface and four points (A, B, C, D) were marked equidistantly along the disk edge. One point D was pressed into the surface elevating the remaining points along the disk edge. The magnitude of the distance of each point A, B, and C to the flat surface was obtained to provide the warpage. Average value and standard deviation of warpage A, B and C was calculated.

The results of Table 2-2 demonstrated that the use of PEI increased the optical transmission, lowered the dissipation factor, and lowered the warpage values in both average and standard deviation. Good mechanical properties were also observed by using PEI.

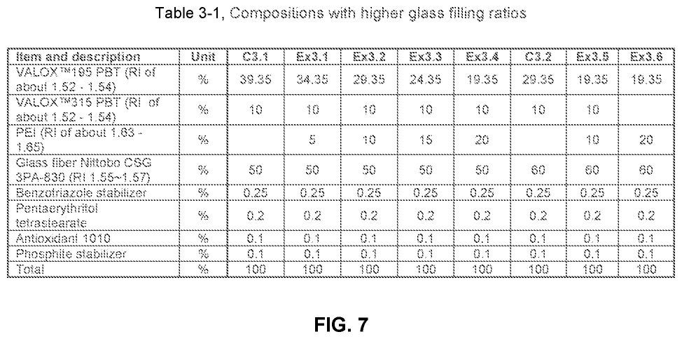

A higher ratio of glass filled PBT examples are presented in Table 3-1 (FIG. 7). 50% and 60% E-glass are prepared in these formulations.

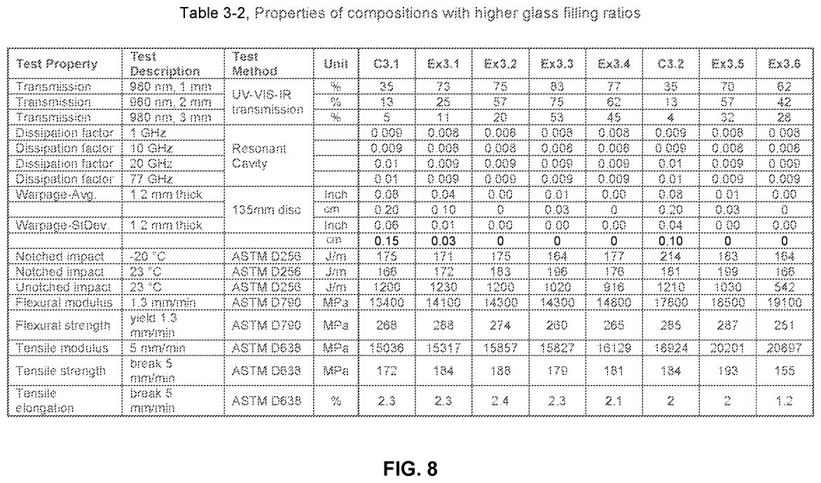

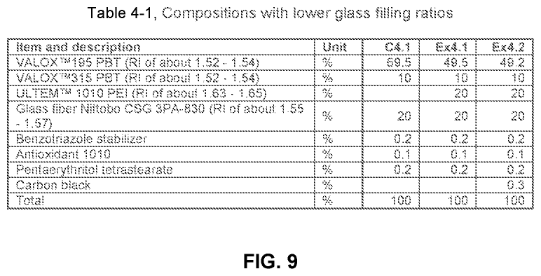

The results of Table 3-2 (FIG. 8) further demonstrated that PEI increased the optical transmission, lowered the dissipation factor, and lowered the warpage values in both average and standard deviation. Good mechanical properties were also observed by using PEI. A lower ratio of glass filled PBT examples are presented in Table 4-1 (FIG. 9). 20% E-glass was used in these formulations.

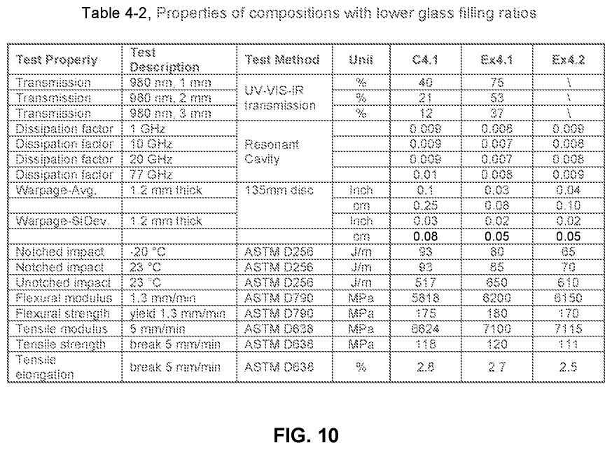

The results of Table 4-2 (FIG. 10) similarly demonstrated that amorphous PEI increased the optical transmission, lowered the dissipation factor, and lowered the warpage values in both average and standard deviation. Good mechanical properties were also observed by using PEI.

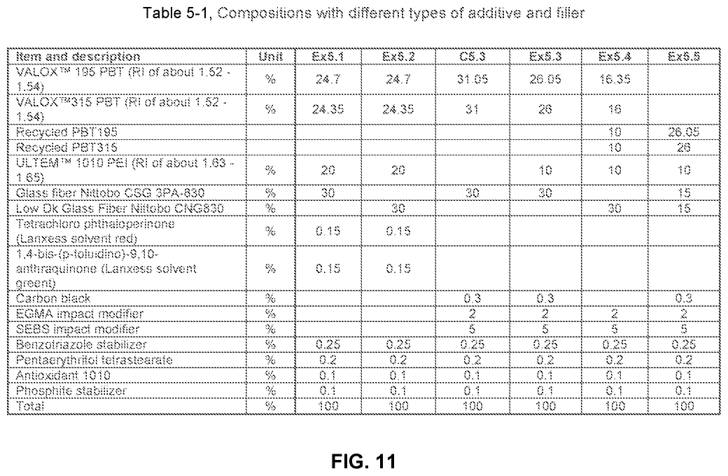

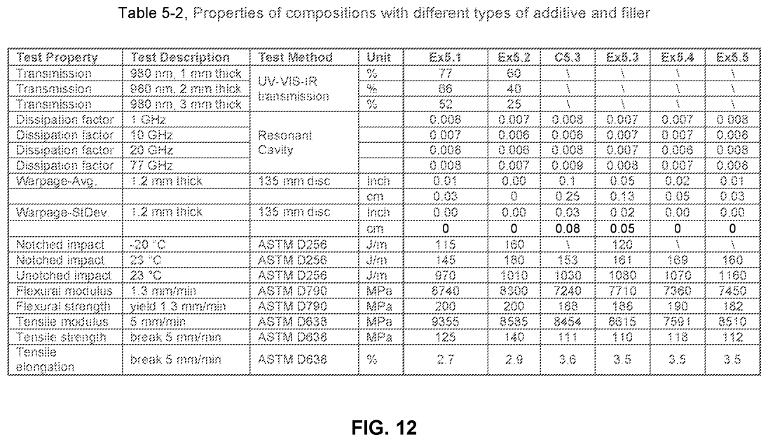

PBT examples including colorants, impact modifiers, recycled polyesters, mixed types of glass fibers are presented in Table 5-1 (FIG. 11). The results of Table 5-2 (FIG. 12) demonstrated that using PEI increased the optical transmission, lowered the dissipation factor, and lowered the warpage values in both average and standard deviation are consistently working in diversified formulations. Ex5.1 and Ex5.2 demonstrated that with the presence of dyes, the optical transmission, the dissipation factor, and the warpage values were still positive compared to the previous controls. Ex5.3 showed with the presence of impact modifiers, the dissipation factor and the warpage values were still improved (lower) compared to the control. Ex5.4 and Ex 5.5 showed that with the presence of recycled polyester, the dissipation factor and the warpage values were also still improved compared to the control. Ex5.5 further showed that when using a mixture of glass fibers, the dissipation factor and warpage were improved as well. In these formulations, good mechanical properties were also observed by using PEI.

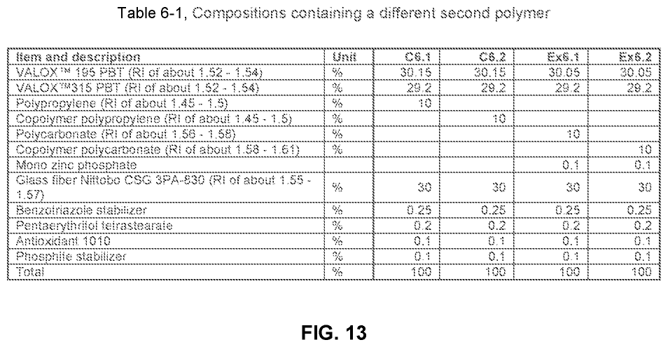

Further comparative samples were observed. PBT examples containing a different second polymer are presented in Table 6-1 (FIG. 13). Not all low Df polymers had the same effect. Polypropylene, is a polymer having the lowest df among engineering plastic polymers (Df about 0.0001), having a R¹ of about 1.45-1.5 (which is lower than that of glass), but having crystalline or semi-crystalline features. An alternative amorphous example was also observed with amorphous polycarbonate and its copolymer.

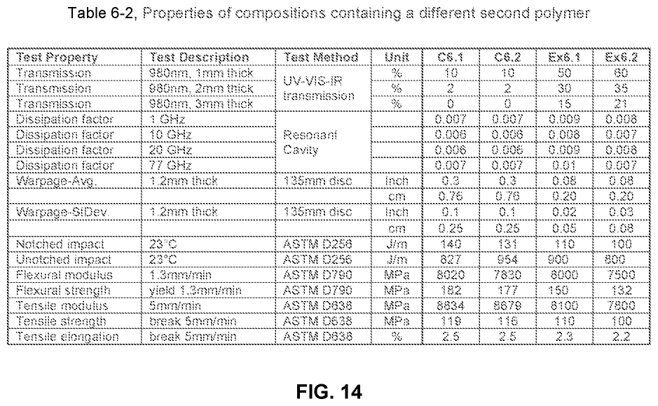

Results of Table 6-2 (FIG. 14) showed that the use of polypropylene in glass filled PBT decreased the optical transmission significantly, and increased the warpage significantly, regardless of the copolymer type of polypropylene (C6.1, C6.2). On the contrary, an amorphous polycarbonate, having a R¹ higher than that of glass, and Df lower than that of PBT, still increased the optical transmission, lowered the dissipation factor, and lowered the warpage.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the disclosure should be determined with reference to the appended claims, along with the full scope of equivalents to which such claims are entitled.

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A thermoplastic composition comprising:
(a) from about 10 wt % to about 87 wt % of at least one crystalline or semi-crystalline polymer, wherein the at least one crystalline or semi-crystalline polymer comprises a crystalline or semi-crystalline polyester;
(b) from about 3 wt % to about 40 wt % of an amorphous polymer resin;
(c) from about 10 wt % to about 70 wt % of a reinforcing filler;
wherein:
the at least one crystalline or semi-crystalline polymer has a lower refractive index than a refractive index of the reinforcing filler when measured using a refractometer,
the amorphous polymer resin has a refractive index value greater than that of the reinforcing filler,
the combined weight percent value of all components does not exceed 100 wt %, and all weight percent values are based on the total weight of the composite, and
the composition exhibits a dissipation factor Df less than the dissipation factor observed for a reference composition in the absence of the amorphous resin.

2. The thermoplastic composition according to claim 1, wherein the crystalline or semi-crystalline polyester comprises polybutylene terephthalate (PBT), polycyclohexylene dimethylene terephthalate (PCT), polyethylene terephthalate glycol (PCTG), polycyclohexylene dimethylene terephthalate glycol (PCTG), polycyclohexylene dimethylene terephthalate acid (PCTA), copolymers thereof, or a combination thereof.

3. The thermoplastic composition according to claim 1, wherein the crystalline or semi-crystalline polyester comprises polybutylene terephthalate (PBT).

4. The thermoplastic composition according to claim 1, wherein the crystalline or semi-crystalline polyester comprises a recycled polybutylene terephthalate.

5. The thermoplastic composition according to claim 1, wherein the amorphous resin comprises a polycarbonate, a copolymer polycarbonate, a dimethyl bis phenol cyclohexane (DMBPC)-co-PBA polycarbonate, a polyphenylene ether PPE, a polyphenylene oxide, a copolymer PPE, a Polyetherimide PEI, a copolymer PEI, or a combination thereof.

6. The thermoplastic composition according to claim 1, wherein the composition further comprises from about 0.01 wt % to about 10 wt % of at least one impact modifier.

7. The thermoplastic composition according to claim 6, wherein the at least one impact modifier comprises polyolefin-acrylate, ethylene-glycidyl methacrylate, ethylene-methyl acrylate-glycidyl methacrylate, ethylene acrylate copolymer, styrene-butadiene-styrene (SBS), styrene-ethylene/1-butene-styrene block copolymer (SEBS), styrene-ethylene-propylene-styrene (SEPS), or a combination thereof.

8. The thermoplastic composition according to claim 1, wherein the reinforcing filler comprises a glass fiber.

9. The thermoplastic composition according to claim 1, wherein the at least one glass fiber comprises E-glass, S-glass, low dk glass fiber, or a combination thereof.

10. The thermoplastic composition according to claim 1, wherein the at least one glass fiber comprises a circular cross section, a non-circular cross section or a combination thereof.

11. The thermoplastic composition of claim 1, wherein the composition exhibits a lower warpage than the warpage observed for a reference composition in the absence of the amorphous resin for warpage measured as a magnitude of displacement from a flat surface.

12. The thermoplastic composition of claim 1, wherein the composition exhibits a higher light transmission value than the light transmission value observed for a reference composition in the absence of the amorphous resin when measured using a UV-VIS-IR spectrometer.

13. The thermoplastic composition of claim 1, wherein the composition exhibits a dissipation factor (Df) of from about 0.001 to about 2 when determined as a ratio of ε″ and ε′ at frequencies from 1-90 GHz when measured according to a resonant cavity method.

14. The thermoplastic composition according to claim 1, wherein the composition exhibits a dissipation factor (Df) of from about 0.001 to about 0.02 when determined as a ratio of ε″ and ε′ at frequencies from 1-100 GHZ when measured according to a resonant cavity method.

15. The thermoplastic composition of claim 1, further comprising an additive material selected from the group consisting of: an antioxidant; a colorant; a de-molding agent; a dye; a flow promoter; a flow modifier; a light stabilizer; a lubricant; a mold release agent; a pigment; a colorant, a quenching agent; a thermal stabilizer; an ultraviolet (UV) absorbant; a UV reflectant; a UV stabilizer; an epoxy chain extender; a flame retardant; and combinations thereof.

16. The thermoplastic composition of claim 1, wherein the composition is a component of an automotive radar sensor.

17. An article comprising the thermoplastic composition of claim 1.
